(19) United States
(12) Patent Application Publication
(10) Pub. No.: US 2013/0135669 A1
(43) Pub. Date: May 30, 2013

(54) IMAGE FORMING SYSTEM AND MANAGEMENT SERVER THEREOF

(71) Applicant: Sharp Kabushiki Kaisha, Osaka (JP)

(72) Inventor: Takashi IDE, Osaka (JP)

(73) Assignee: SHARP KABUSHIKI KAISHA, Osaka (JP)

(21) Appl. No.: 13/678,698

(22) Filed: Nov. 16, 2012

(30) Foreign Application Priority Data
Nov. 24, 2011 (JP) 2011-255691

(51) Int. Cl. G06K 15/02

(52) U.S. Cl. CPC G06K 15/02
USPC 358/1.15

(57) ABSTRACT

A server includes: a receiving unit receiving, from each of a plurality of image forming apparatuses, a schedule including information related to a period in which each image forming apparatus enters an energy saving mode; an analyzing unit analyzing the received schedules group by group; a changing unit changing the schedule or schedules of image forming apparatuses belonging to each group in accordance with the result of analysis; and a transmitting unit transmitting the changed schedule to a corresponding image forming apparatus. Each image forming apparatus operates in accordance with the schedule transmitted from the server. Thus, image forming apparatuses belonging to a group as a whole can be operated appropriately.

### CROSS-REFERENCE TO RELATED APPLICATIONS

This nonprovisional application claims priority under 35 U.S.C. §119(a) on Patent Application No. 2011-255691 filed in Japan on Nov. 24, 2011, the entire contents of which are hereby incorporated by reference.

### BACKGROUND OF THE INVENTION

1. Field of the Invention

The present invention relates to an image forming system and a management server thereof, capable of optimizing schedule of transition to an energy saving mode set in each of a plurality of image forming apparatuses installed, for example, in an office, to realize appropriate operations of the plurality of image forming apparatuses in the office as a whole.

2. Description of the Background Art

As one type of image processing apparatuses as electronic equipment, an image forming apparatus (typically a copy machine) for forming an image on a sheet of recording paper has been introduced to many places of business (companies and offices). In such a place of business, it is a common practice to have an image forming apparatus having a printer function or copy function connected to a network and to share the apparatus by a plurality of users. An MFP (MultiFunction Peripheral) as one type of such image forming apparatuses has a plurality of basic operational modes including a copy mode, a facsimile mode (hereinafter facsimile will be also denoted as FAX), a network compatible printer mode and a scanner mode.

Recently, office environments in which states of operations of electronic equipment, air conditioning and so on provided in an office are managed in a collective manner and regulated to save power consumption as much as possible have come to be common. In an image forming apparatus such as an MFP, it is a general practice to set, MFP by MFP, a schedule of transition from a normal standby state (allowing immediate copying operation) to a power saving move of smaller power consumption. Such a schedule is set in individual MFP in accordance with the state of use in the office.

By way of example, Japanese Patent Laying-Open No. 2008-118534 (hereinafter referred to as '534 Reference) discloses a technique in which a monitoring server connected to a network controls sleep state of a plurality of image forming apparatuses connected to the network. The monitoring server acquires and stores sleep start events (to enter power saving state) and sleep cancel events (to return from the power saving state) from each of the image forming apparatuses that are monitored, and analyzes the stored information. Based on the result of analysis, the monitoring server determines sleep interval (time period to enter the sleep state in the absence of any instruction for processing) for each image forming apparatus, or determines an image forming apparatus of which sleep state is to be cancelled.

As described above, in an office in which a plurality of MFPs are installed and scheduled one by one, it is often the case that schedule settings of MFPs are not consistent with each other. For example, if some or all of the MFPs have the operating time slots (that is, time slot not set to the energy saving mode) overlapping with each other, it follows that a plurality of MFPs are used simultaneously, resulting in abrupt increase of power consumption in the office. This may pose a problem in a situation of power shortage. If most of or all of the MFPs have non-operating time slots (that is, time slots set to the energy saving mode) overlapping with each other, it is difficult to find an MFP that is immediately available. This leads to lower efficiency, and possibly interferes with business operations.

Such problems are not at all considered in '534 Reference, and these problems cannot be solved by the invention disclosed in '534 Reference.

In view of the problems described above, it is desirable to provide an image forming system and a management server therefor, capable of optimizing schedule of transition to an energy saving mode set in each of a plurality of image forming apparatuses installed in an office, to realize appropriate operations in the office as a whole.

### SUMMARY OF THE INVENTION

The present invention provides a server computer, including: a receiving unit receiving, through a network, from each of a plurality of image forming apparatuses, a schedule including information related to a period in which each image forming apparatus enters an energy saving mode; an analyzing unit analyzing the received schedule; a changing unit changing the schedule in accordance with the result of analysis by the analyzing unit; and a transmitting unit transmitting the changed schedule to the corresponding image forming apparatus.

Preferably, the analyzing unit specifies, in schedules of at least two of the plurality of image forming apparatuses among the plurality of image forming apparatuses, a normal mode overlapping period in which the normal mode periods overlap, the normal mode period being a period not set to the energy saving mode, and the changing unit changes the schedules of the at least two image forming apparatuses such that, in the normal mode overlapping period, except for one of the at least two image forming apparatuses, the remaining image forming apparatuses are set to the energy saving mode.

More preferably, the changing unit changes the schedules of the at least two image forming apparatuses such that, in the normal mode overlapping period, except for one image forming apparatus having the smallest power consumption, the remaining image forming apparatuses are set to the energy saving mode.

More preferably, the analyzing unit calculates total sum of power use of prescribed image forming apparatuses not set to the energy saving mode among the plurality of image forming apparatuses and specifies an excess period in which the total sum exceeds a prescribed value in the schedule; and the changing unit sets at least one of the prescribed image forming apparatuses to the energy saving mode so as to have the total sum equal to or lower than the prescribed value in the excess period, and thereby changes the schedule of the image forming apparatus.

Preferably, the analyzing unit specifies, in the schedules of at least two of image forming apparatuses among the plurality of image forming apparatuses, an energy saving mode overlapping period in which periods set to the energy saving mode overlap; and the changing unit changes the schedules of the at least two image forming apparatuses such that of the at least two image forming apparatus, except for one of the image forming apparatuses, the remaining image forming apparatuses are not set to the energy saving mode in the energy saving mode overlapping period.

More preferably, the receiving unit receives information related to operating time of each image forming apparatus, from each of the plurality of image forming apparatuses; the analyzing unit includes a calculating unit calculating relative usage rate from the information related to the operating time, for the plurality of image forming apparatuses; and the changing unit changes the schedules of the plurality of image forming apparatuses such that the time period in which an image forming apparatus having smaller usage rate is set to the energy saving mode becomes longer.

More preferably, the receiving unit receives information related to remaining amount of consumables of each image forming apparatus from each of the plurality of image forming apparatuses; the analyzing unit specifies an image forming apparatus of which remaining amount of consumables is equal to or lower than a prescribed amount; and the changing unit changes the schedule of the specified image forming apparatus such that the time period in which the specified image forming apparatus is set to the energy saving mode is made longer than the image forming apparatuses other than the specified image forming apparatus.

The present invention provides an image forming system, including: the above-described server computer; and a plurality of image forming apparatuses. Each of the image forming apparatuses transmits a schedule including information related to a period in which each image forming apparatus enters an energy saving mode to the server computer, receives the schedule changed by the server computer, and operates in accordance with the received schedule.

By the present invention, the schedule of transition to the energy saving mode set individually in each of the plurality of image forming apparatuses installed in an office or the like can be adjusted with each other and optimized. Therefore, appropriate operations of the plurality of image forming apparatuses in the office as a whole can be realized.

Specifically, the schedule of each of the image forming apparatuses is changed such that the period set to the normal mode (not set to the energy saving mode) does not overlap, whereby the power consumption of the plurality of image forming apparatuses combined can appropriately be reduced. Here, by setting the image forming apparatuses other than the one having the smallest power consumption to the energy saving mode, the overall power consumption can further be reduced.

Since the schedule of each of the image forming apparatuses is changed such that the total sum of power used by the image forming apparatuses set to the normal mode in a prescribed time period does not exceed a prescribed value, it becomes possible to realize power conservation by the plurality of image forming apparatuses as a whole, while decrease in efficiency of business operation is minimized.

Since the schedule of each of the image forming apparatuses is changed such that the period set to the energy saving mode does not overlap, in a time slot in which business efficiency is given higher priority than energy saving, high efficiency of business operations can be realized while power consumption of the plurality of image forming apparatuses as a whole is reduced.

Since the schedule of each of the image forming apparatuses is changed in accordance with the operation time (usage rate) of the image forming apparatuses, it becomes possible to realize power conservation by the plurality of image forming apparatuses as a whole, while decrease in efficiency of business operation is minimized.

Since the schedule of each of the image forming apparatuses is changed in accordance with the remaining amount of consumables such as toner and recording paper, it becomes less likely that the image forming apparatus is stopped because of shortage of consumables (and the temperature of fixing unit decreases). Therefore, excess power consumption and wasteful time necessary to resume the normal standby state can be avoided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of an image forming system in accordance with an embodiment of the present invention.

FIG. 2 is a perspective view showing an appearance of a first image forming apparatus shown in FIG. 1.

FIG. 3 is a block diagram schematically showing an internal configuration of the first image forming apparatus of FIG. 2.

FIG. 4 is a cross-sectional view showing a configuration of a printing unit shown in FIG. 3.

FIG. 5 is a block diagram showing an internal configuration of a server shown in FIG. 1.

FIG. 6 is a flowchart representing a control structure of a program executed in the server shown in FIG. 1.

FIG. 7 shows an example of a schedule which the server obtained from each image forming apparatus.

FIG. 8 is a flowchart representing an example of a control structure of an optimizing program.

FIG. 9 shows a schedule optimized by the program of FIG. 8.

FIG. 10 is a flowchart representing a control structure of a program executed by the first image forming apparatus.

FIG. 11 is a flowchart representing an example of a control structure of an optimizing program.

FIG. 12 is a flowchart representing an example of a control structure of an optimizing program different from FIG. 11.

FIG. 13 shows a schedule optimized by the program of FIG. 12.

FIG. 14 is a flowchart representing an example of a control structure of an optimizing program different from FIGS. 11 and 12.

FIG. 15 shows a result of calculation used in the program of FIG. 14.

FIG. 16 shows usage rates used in the program of FIG. 14.

FIG. 17 shows a schedule optimized by the program of FIG. 14.

FIG. 18 is a flowchart representing an example of a control structure of an optimizing program different from FIGS. 11, 12 and 14.

FIG. 19 shows a schedule optimized by the program of FIG. 18.

FIG. 20 is a flowchart representing a control structure of a program executed by the first image forming apparatus, different from FIG. 10.

FIG. 21 is a block diagram showing a system configuration different from FIG. 1.

### DESCRIPTION OF THE PREFERRED EMBODIMENTS

In the following embodiment, the same components are denoted by the same reference characters. Their names and functions are also the same. Therefore, detailed description thereof will not be repeated.

The image forming system in accordance with an embodiment of the present invention includes a plurality of image forming apparatuses and a server computer (in the following, referred to as a server) connected to each other by a network such as a LAN. The image forming apparatus is a digital MFP having a plurality of functions including printer function, copy function, facsimile function, scanner function and the like. Each image forming apparatus stores a schedule designating a time slot or time slots to be set to an energy saving mode to reduce power consumption and, in accordance with the schedule, it makes a transition from a normal state of operation (hereinafter referred to as a normal mode) to the energy saving mode, or from the energy saving mode to the normal mode. The server manages the schedules related to the energy saving mode set in the plurality of image forming apparatuses. Specifically, the server optimizes the schedules of respective image forming apparatuses for the overall system, and operates each of the image forming apparatuses in accordance with the optimized schedules.

The energy saving mode of an image forming apparatus includes various different modes, such as “auto power shut-off mode” and “preheat mode.” The auto power shut-off mode refers to a standby mode with minimum power consumption, in which power supply to the operation unit and the fixing unit is stopped in the absence of any operation on the operation unit. Though this mode attains high energy saving ratio, it takes relatively long time to recover when operated. The preheat mode refers to a standby mode with small power consumption in which temperature of the fixing unit is lowered. Though the energy saving ratio of preheat mode is lower than that of auto power shut-off mode, it takes shorter time to recover when operated. The time period until transition is made to the auto power shut-off mode or to the preheat mode in the absence of any operation on the operation unit is appropriately set (for example, in the order of minutes) for each image forming apparatus by an administrator or the like. Setting to stop power supply to the operation unit in the preheat mode is also possible.

In the present specification, the energy saving mode is not limited to these. The schedule related to the energy saving mode (hereinafter referred to as energy saving schedule) means data having time slot (designated, for example, by a start time and an end time) related to the energy saving mode (including the auto power shut-off mode and the preheat mode). If the image forming apparatus has a function of automatically turning ON or OFF at a preset time, the schedule related to the energy saving mode may include the data of power ON and/or power OFF of the image forming apparatus.

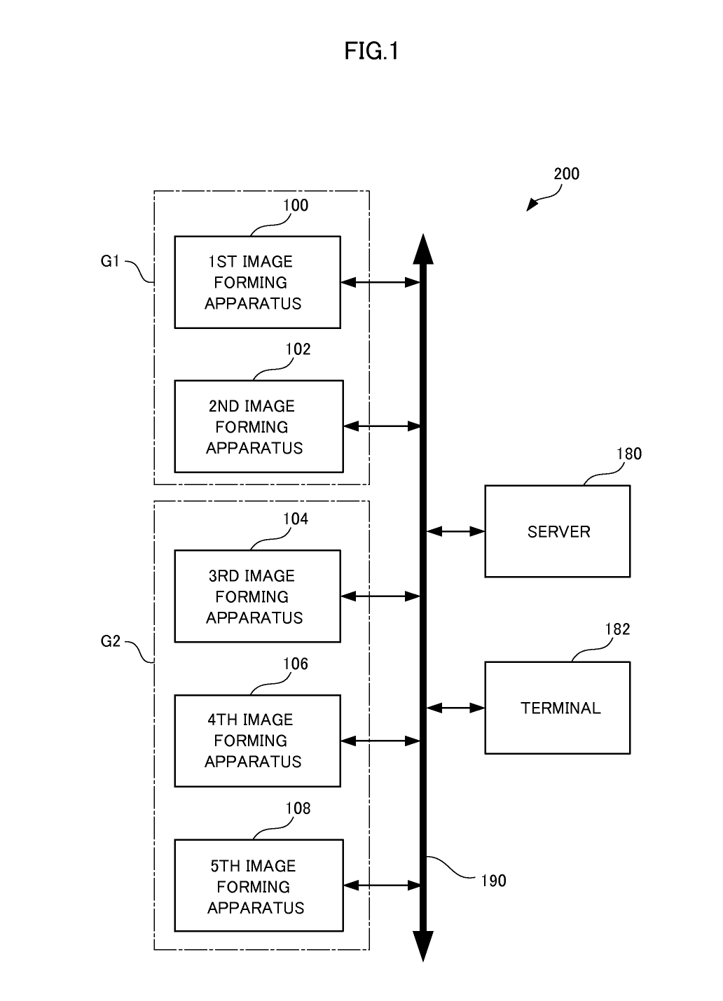

Referring to FIG. 1, an image forming system 200 in accordance with the present embodiment includes first to fifth image forming apparatuses 100, 102, 104, 106 and 108, a server 180, a terminal 182 and a network 190 to which these are connected. Terminal 182 is, for example, a computer. Server 180 is a server computer managing the first to fifth image forming apparatuses 100 to 108. The first to fifth image forming apparatuses 100 to 108 are divided into two groups. The first and second image forming apparatuses 100 and 102 are, for example, installed on the first floor of an office, and belong to a first group G1. The third to fifth image forming apparatuses 104, 106 and 108 are installed on the second floor of the office and belong to the second group G2.

In addition to the first to fifth image forming apparatuses 100 to 108, image forming system 200 may include an image forming apparatus or apparatuses. Five apparatuses are shown as representatives in FIG. 1. Similarly, image forming system 200 may include a plurality of terminals and a plurality of print servers. Only one of each is shown as a representative in FIG. 1. It is assumed that the second to fifth image forming apparatuses may not be of the same type as the first image forming apparatus, but they have comparable functions. The following description related to the configuration and functions of first image forming apparatus 100 also applies to the second to fifth image forming apparatuses 102 to 108.

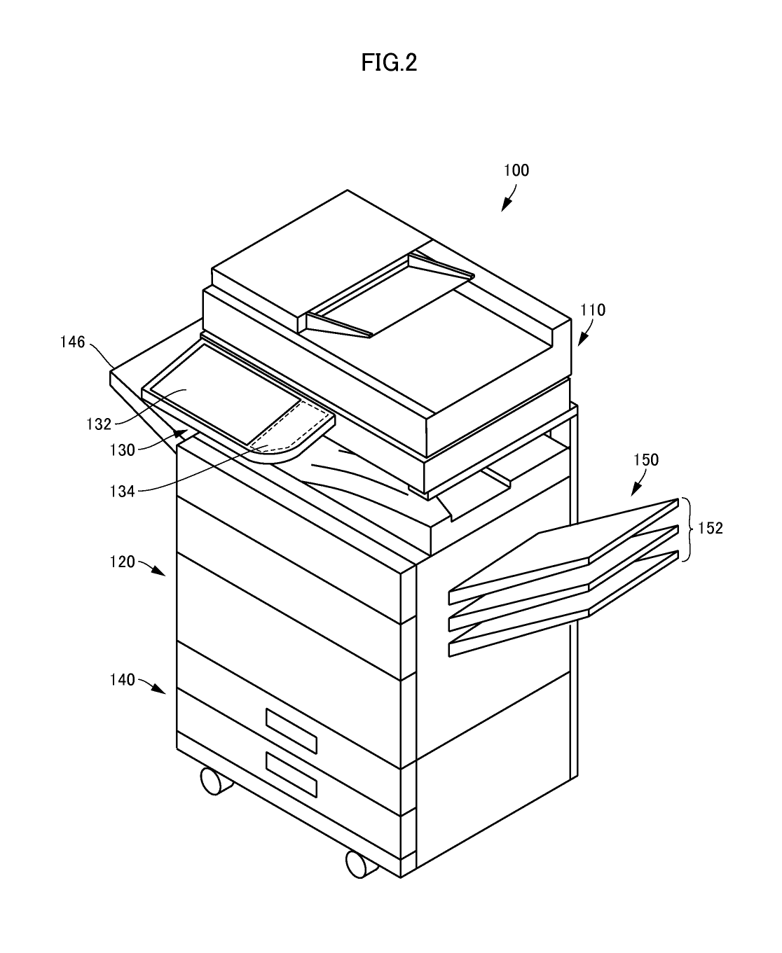

Referring to FIG. 2, image forming apparatus 100 in accordance with the present embodiment includes an image reading unit 110, an image forming unit 120, an operation unit 130, a paper feed unit 140, a manual paper feed tray 146, and a paper discharge unit 150. Operation unit 130 includes a touch-panel display 132 and an operation key unit 134. Touch-panel display 132 includes a display panel implemented by a liquid crystal panel or the like, and a touch-panel arranged on the display panel and detecting a touched position. On operation key unit 134, a number of function keys, not shown, are arranged.

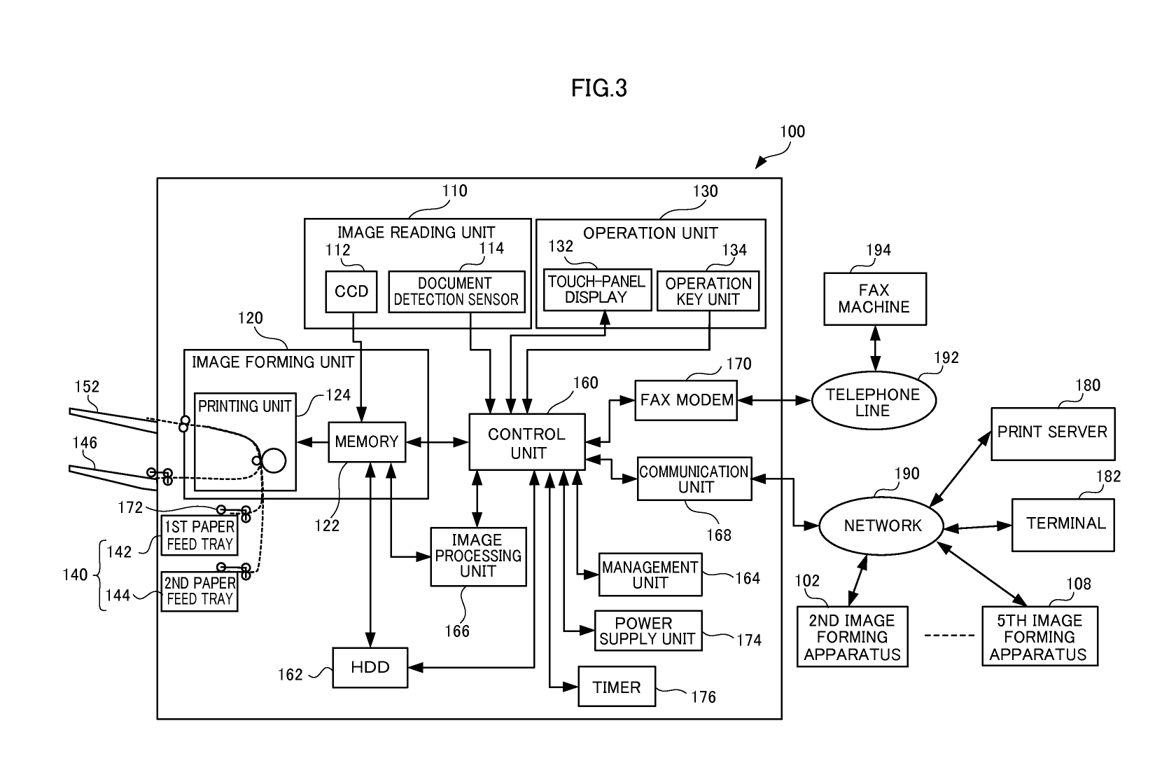

Referring to FIG. 3, first image forming apparatus 100 is connected to a telephone line 192, in addition to network 190. In addition to image reading unit 110, image forming unit 120 and operation unit 130 as described above, first image forming apparatus 100 includes a control unit 160, a hard disk drive (hereinafter denoted as HDD) 162, a management unit 164, an image processing unit 166, a communication unit 168, a FAX modem 170, a power supply unit 174, and a timer 176.

Image reading unit 110 reads a document and inputs image data. Control unit 160 is, for example, a CPU (Central Processing Unit). Control unit 160 controls various units and components of first image forming apparatus 100 using an ROM (Read Only Memory) (not shown) and an RAM (Random Access Memory) (not shown). ROM is a non-volatile storage device that retains data even when power is turned off. ROM stores programs and data necessary for controlling operations of image forming apparatus 100. RAM is a volatile storage device. Control unit 160 reads a program from ROM to RAM and executes the program using a part of RAM as a work area. Specifically, control unit 160 controls various components and units forming first image forming apparatus 100 and realizes each of the functions of first image forming apparatus 100 in accordance with a program or programs stored in ROM.

Operation unit 130 receives inputs from the user including instructions to first image forming apparatus 100. Communication unit 168 communicates with terminal 182, second to fifth image forming apparatuses 102 to 108 and server 180, through network 190. Image forming unit 120 prints image data on a sheet of recording paper. HDD 162 stores image data. Management unit 164 stores control information, setting information and the like of first image forming apparatus 100.

Control unit 160 controls overall operation of first image forming apparatus 100 based on the information stored in management unit 164. Image processing unit 166 executes various image processing operations on the read image data. FAX modem 170 communicates with a facsimile machine 194 through telephone line 192.

Control unit 160 obtains current time from timer 176 appropriately, and in accordance with the schedule stored in HDD 162, operates in a prescribed operational mode. The schedule is set in advance by the administrator or the like through operation unit 130. In the normal mode, control unit 160 controls power supply unit 174 such that the power supplied from the outside to the first image forming apparatus 100 is supplied to the units and components through a power supply line (not shown). In the energy saving mode, control unit 160 controls power supply unit 174 such that power supply to a prescribed unit or units (for example, operation unit 130 and fixing unit, which will be described later) is suspended.

In the example shown in FIG. 3, the components and units are connected to control unit 160 and, therefore, data is transmitted between each of the components and units through control unit 160. The configuration, however, is not limiting, and a data bus may be provided and each of the components and units may be connected through the data bus. In that case, each of the components and units are controlled by control unit 160 and data is transmitted between each of the components and units, through the data bus.

Paper feed unit 140 includes first and second paper feed trays 142 and 144. Manual paper feed tray 146 is for manually feeding sheets of recording paper.

First image forming apparatus 100 is capable of transmitting/receiving image data to/from facsimile machine 194 by FAX. If network 190 is further connected to the external Internet, first image forming apparatus 100 is capable of transmitting/receiving image data to/from a terminal such as a PC connected to the Internet by using, for example, electronic mail.

In the following, components and units included in first image forming apparatus 100 shown in FIG. 3 will be described in detail. Image reading unit 110 reads a document and produces image data. Image reading unit 110 includes, for example, a CCD (Charge Coupled Device) 112 as an image reading device, and a document detection sensor 114 for detecting a document set on a platen, an automatic document feeder (ADF) or the like.

Operation unit 130 includes an operation key unit 134 provided with various input keys (hardware keys) and a touch-panel display 132 having a touch-panel arranged on a display panel such as an LCD (Liquid Crystal Display). The user inputs operation instructions or various settings to first image forming apparatus 100 through operation unit 130. An authentication information input device for inputting authentication information of the user who is to use the first image forming apparatus 100 may be provided on operation unit 130. Various methods of inputting user authentication information are available, including direct input of user code, input by reading information on an ID card, or input by reading biometric information (such as fingerprint) of the user. User authentication of first image forming apparatus 100 can be realized by any of these methods. It is possible for the user to instruct interruption, for suspending a recorded job to start another job.

Control unit 160 monitors user operation on touch-panel display 132, input keys and the like provided on operation unit 130, and displays information to be notified to the user, such as the information related to the state of first image forming apparatus 100, on touch-panel display 132.

Image forming unit 120 processes image data and outputs the result. Image forming unit 120 includes a memory 122 and a printing unit 124. Printing unit 124 forms an image on a sheet of recording paper.

Image forming unit 120 temporarily stores image data read by image reading unit 110 in memory 122, and thereafter, stores the image data on memory 122 in HDD 162. Further, image forming unit 120 reads the image data stored in HDD 162 to memory 122. The read data is transferred to printing unit 124, and printed as an image on a sheet of recording paper and output.

HDD 162 stores the input image data. HDD 162 is a magnetic recording medium and it is capable of storing and successively processing a large amount of image data. Thus, first image forming apparatus 100 can process instructions from a plurality of users efficiently.

Image processing unit 166 is controlled by control unit 160 that receives a user instruction from operation unit 130. Image processing unit 166 reads image data from memory 122, executes the instructed image processing, and stores the result in memory 122. The image data as the result of processing is displayed on touch-panel display 132 through control unit 160. Thereafter, the image data in memory 122 is, in response to a user instruction, transferred to printing unit 124 and printed on a sheet of recording paper, output to telephone line 192 through FAX modem 170, or output to network 190 through communication unit 168.

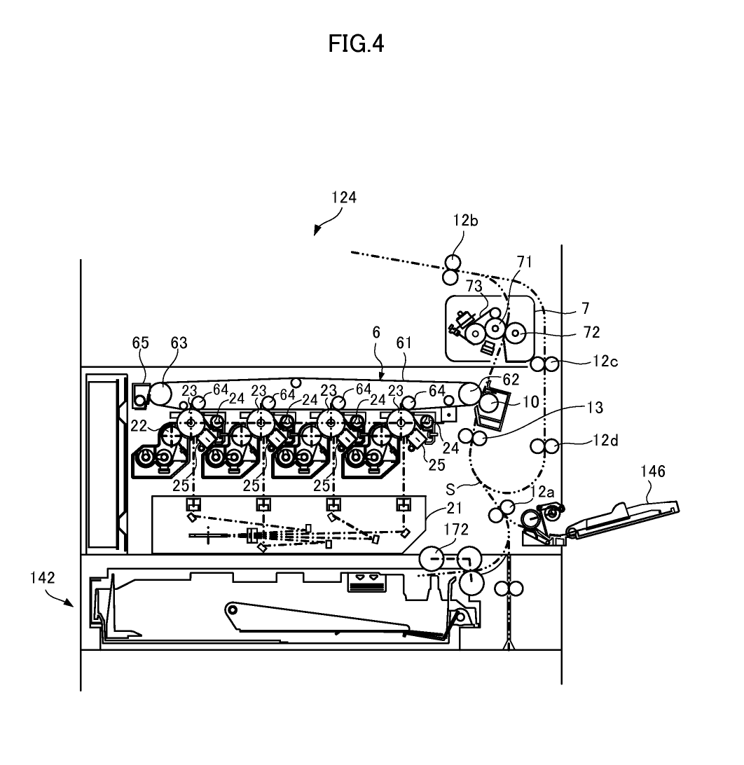

Image formation on a sheet of recording paper in first image forming apparatus 100 will be described in greater detail. Referring to FIG. 4, printing unit 124 includes an optical scanning device 21, a developer 22, a photoreceptor drum 23, a cleaner unit 24, a charger 25, an intermediate transfer belt unit 6, and a fixing unit 7. The image data handled in first image forming apparatus 100 are color image data using colors of black (K), cyan (C), magenta (M) and yellow (Y), that is, image data separated to components of these four colors. Therefore, in order to form four different latent images of respective colors, four developers 22, four photoreceptor drums 23, four chargers 25 and four cleaner units 24 are provided. These components form four image stations for processing black, cyan, magenta and yellow, respectively.

Charger 25 is a device for uniformly charging the surface of photoreceptor drum 23 to a prescribed potential. Other than the charger type device shown in FIG. 4, a contact roller type, or a brush type charger may be used.

Optical scanning device 21 is a laser scanning unit (LSU) including a laser emitting unit and a reflection mirror. In optical scanning device 21, a polygon mirror for laser beam scanning and an optical element including a lens and a mirror for guiding the laser beam reflected by the polygon mirror to photoreceptor drum 23 are arranged. Other than such a configuration, a configuration having an EL or LED write head having light emitting elements arranged in an array, may be used as optical scanning device 21.

Optical scanning device 21 exposes the charged photoreceptor drum 23 in accordance with the input image data, and thereby forms an electrostatic latent image in accordance with the image data on the surface of photoreceptor drum 23. Developer 22 turns the electrostatic latent images formed on respective photoreceptor drums 23 to visible images with toners of four colors (YMCK), respectively. Cleaner unit 24 removes and recovers the toner left on the surface of each photoreceptor drum 23, after development and image transfer.

Intermediate transfer belt unit 6 arranged above photoreceptor drum 23 includes an intermediate transfer belt 61, an intermediate transfer belt driving roller 62, an intermediate transfer belt driven roller 63, an intermediate transfer roller 64 and an intermediate transfer belt cleaning unit 65. There are four intermediate transfer rollers 64, corresponding to respective colors of Y, M, C and K.

Around intermediate transfer belt driving roller 62, intermediate transfer belt driven roller 63, and intermediate transfer roller 64, intermediate transfer belt 61 is wound and driven to rotate. Each intermediate transfer roller 64 supplies transfer bias, which will be described later, for transferring the toner image on the corresponding photoreceptor drum 23 to intermediate transfer belt 61.

Intermediate transfer belt 61 is provided to be in contact with each photoreceptor drum 23. By successively transferring the toner images of respective colors formed on photoreceptor drums 23 onto intermediate transfer belt 61 to be superposed on the last, a color toner image (multi-color toner image) is formed on intermediate transfer belt 61. Intermediate transfer belt 61 is formed as an endless belt, using a film having the thickness of about 100 μm to 150 μm.

Transfer of the toner image from photoreceptor drum 23 to intermediate transfer belt 61 is done by intermediate transfer roller 64 that is in contact with the back side of intermediate transfer belt 61. A high voltage transfer bias (high voltage of a polarity (+) opposite to the charged polarity (−) of the toner) is applied to intermediate transfer roller 64, in order to transfer the toner image. Intermediate transfer roller 64 has a metal shaft (for example, of stainless steel) of 8 to 10 mm in diameter as a base, with its surface covered by a conductive elastic member (such as EPDM or urethane foam). Because of this conductive elastic member, uniform high voltage can be applied to intermediate transfer belt 61. Though a roller-shaped transfer electrode is used in the present embodiment, a brush or the like may be used as an alternative.

The electrostatic images turned to visual images in accordance with the hue on respective photoreceptor drums 23 as described above are superposed on intermediate transfer belt 61. Information of the thus superposed images (density distribution of toner) is transferred to a sheet of recording paper, as intermediate transfer belt 61 is rotated, by a transfer roller 10 arranged at the position of contact between the intermediate transfer belt 61 and the sheet of recording paper.

At this time, intermediate transfer belt 61 and transfer roller 10 are brought into pressure-contact with a prescribed nip, and a voltage (high voltage of a polarity (+) opposite to the charged polarity (−) of the toner) for transferring the toner to the sheet of recording paper is applied to transfer roller 10. Further, in order to constantly secure the nip mentioned above, a hard material (metal or the like) is used for one of the transfer roller 10 and intermediate transfer belt driving roller 62, and a soft material such as soft roller (elastic rubber roller, foam resin roller or the like) is used for the other one.

Further, as described above, the toner adhering to intermediate transfer belt 61 by the contact with photoreceptor drum 23, or toner not transferred to the sheet of recording paper by transfer roller 10 but left on intermediate transfer belt 61 may cause undesirable mixture of toner colors in subsequent process steps. Therefore, the toner left on intermediate transfer belt 61 is removed and recovered by intermediate transfer belt cleaning unit 65. In intermediate transfer belt cleaning unit 65, a cleaning blade that is brought into contact with intermediate transfer belt 61 is provided as a cleaning member. Intermediate transfer belt 61 is supported by intermediate transfer belt driven roller 63 at a portion where the cleaning blade contacts.

FIG. 4 shows a paper feeding path S formed in a substantially vertical direction, for feeding sheets of recording paper in first paper feed tray 142 and manual paper feed tray 146 to paper discharge tray 152 through transfer roller 10 and fixing unit 7. In the vicinity of paper feeding path S, a pick-up roller 172, a plurality of conveyor roller pairs 12a to 12d, a registration roller pair 13, a transfer roller 10, fixing unit 7 and the like are arranged.

Conveyor roller pairs 12a to 12d are small rollers for promoting and assisting feeding of the recording paper, and a plurality of conveyor roller pairs are provided along paper feeding path S. Pick-up roller 172 is arranged near an end of first paper feed tray 142, picks up sheets of recording paper one by one from first paper feed tray 142 and supplies the sheets to paper feeding path S.

Registration roller pair 13 temporarily holds the sheet of recording paper fed along paper feeding path S. Then registration roller pair 13 feeds the sheet of recording paper to transfer roller 10 at such timing when the leading edge of toner image on intermediate transfer belt 61 is aligned with the leading edge of the sheet of recording paper.

Fixing unit 7 includes a heat roller 71 and a pressure roller 72. Heat roller 71 and pressure roller 72 rotate, with the sheet of recording paper pinched therebetween. Heat roller 71 is heated from outside, by an external heating belt 73. Here, heat roller 71 is set to a prescribed fixing temperature by control unit 160, based on a signal from a temperature detector (not shown). Heat roller 71 presses with heat, together with pressure roller 72, the toner to the sheet of recording paper, and thus melts, mixes and causes pressure-contact of multi-color toner image that has been transferred to the sheet of recording paper and thereby heat-fixing the image on the sheet of recording paper.

In the energy saving mode, power supply from power supply unit 174 to fixing unit 7 is stopped or limited. By way of example, in the auto power shut-off mode, power supply to fixing unit 7 (more specifically, to the heater heating external heating belt) is stopped. In the preheat mode, the set temperature of heat roller 71 is made lower than in the normal mode, and power supply to fixing unit 7 is limited.

Various modes for executing functions available in the first image forming apparatus 100 (copy function, printer function, scanner function and facsimile function) will be briefly described.

(Copy Mode)

When image forming apparatus 100 is used as a copy machine, image data of the document read by image reading unit 110 is output as a copy from image forming unit 120.

By the CCD 112 provided at image reading unit 110, images of the document set at a reading position can be electronically read. The read image data is completed as output data (print data) on memory 122, and stored in HDD 162. If there is a plurality of documents, the reading and storage operations are repeated. Thereafter, based on the process mode instructed from operation unit 130, the image data stored in HDD 162 is successively read at appropriate timing and transmitted to memory 122. Then, the image data is transmitted from memory 122 to printing unit 124 timed with image formation at printing unit 124.

When the read image is to be printed on a plurality of pages, the image data is stored page by page as output data in the similar manner in HDD 162, transmitted from HDD 162 to memory 122 and transmitted to printing unit 124 timed with image formation, repeatedly for the number of pages to be output.

Specifically, as described above, optical scanning device 21 exposes charged photoreceptor drum 23 in accordance with the input image data, whereby an electrostatic latent image in accordance with the image data is formed on the surface of photoreceptor drum 23. The electrostatic latent image on photoreceptor drum 23 is transferred to intermediate transfer belt 61. The electrostatic latent image is turned to visible image on intermediate transfer belt 61, and transferred to a fed sheet of recording paper by means of registration roller pair 13. Thereafter, the recording paper is heated and pressed by fixing unit 7, and discharged to discharge tray 152.

(Printer Mode)

When image forming apparatus 100 is used as a printer, image data received through communication unit 168 is output from image forming unit 120 through memory 122 and the like.

Communication unit 168 is connected to network 190 in wired or wireless manner, and receives image data from terminal 182 as an external device connected to network 190. The received image data is transmitted page by page as output image data to memory 122, and stored in HDD 162. Then, the image data is again transmitted from HDD 162 to memory 122 and transmitted to printing unit 124 as in the copy mode described above, and image formation takes place.

(Scanner Mode)

When image forming apparatus 100 is used, for example, as a network scanner, image data of the document read at image reading unit 110 is transmitted from communication unit 168 through network 190 to an arbitrary terminal (for example, terminal 182). Here again, the document is electronically read by CCD 112 provided at image reading unit 110. The read image data is completed as output data on memory 122, and stored in HDD 162. Thereafter, the image data is again transmitted from HDD 162 to memory 122, and after communication with a transmission destination designated through operation unit 130 is established, transmitted from communication unit 168 to the designated transmission destination.

(Facsimile Mode)

The first image forming apparatus 100 has FAX modem 170 connected to telephone line 192 and communication unit 168 connected to the Internet, as described above. Therefore, first image forming apparatus 100 is capable of FAX transmission/reception to/from facsimile machine 194 through telephone line 192.

When first image forming apparatus 100 is used as a facsimile machine, data received by FAX from facsimile machine 194 is formed as image data on memory 122, and in the similar manner as described above, storage in HDD 162 and printing by printing unit 124 can be executed. Further, first image forming apparatus 100 can read image data from HDD 162, convert the data to a data format for FAX communication and transmit the converted data to facsimile machine 194.

As described above, image transmission in the scanner mode and the facsimile mode does not involve printing on a sheet of recording paper and, therefore, power supply to the fixing unit may be stopped. Therefore, if it is a process that can be executed while stopping power supply to the fixing unit, for instance, if scanning or facsimile transmission is instructed in the auto power shut-off mode or in the preheat mode, the image forming apparatus may be adapted to execute the instructed image transmission without returning to the normal mode (for example, with power supply to the fixing unit kept stopped).

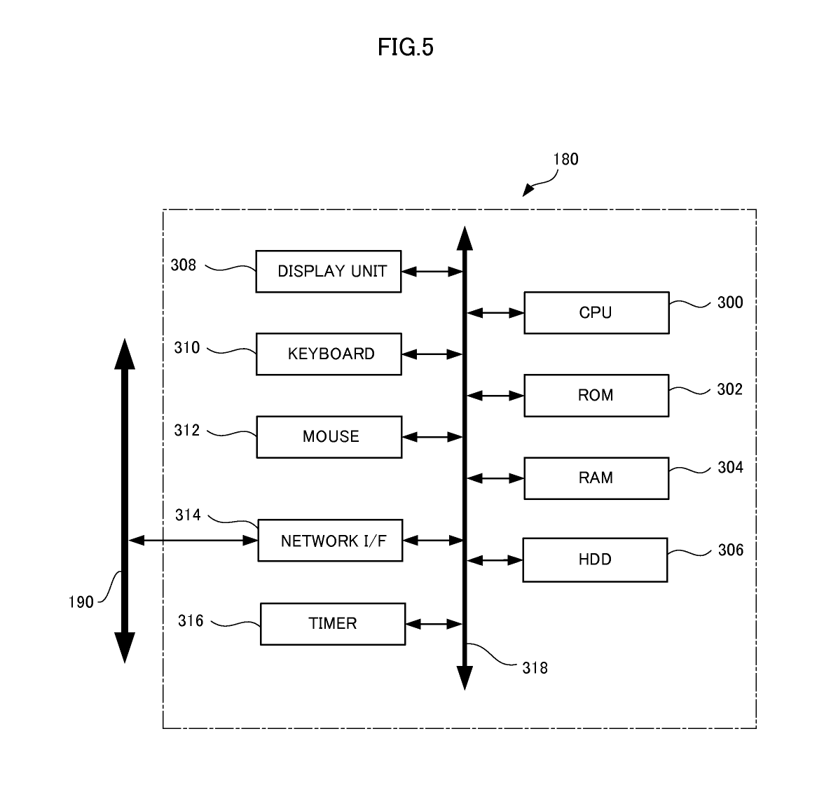

Referring to FIG. 5, server 180 includes, as a general purpose computer, a CPU 300, an ROM 302, an RAM 304, an HDD 306, a display unit 308, a keyboard 310 for a computer, a mouse 312 for the computer, a network I/F 314, a timer 316 and a bus 318. Exchange of data (including control information) between each of these components is done through bus 318. CPU 300 reads a prescribed program stored in ROM 302 to RAM 304 through bus 318, and executes the program using part of RAM 304 as a work area. At the time of executing the program, CPU 300 obtains current time information from timer 316 as needed.

Display unit 308 includes a display device capable of displaying an image, such as a liquid crystal display, and a video memory. Video memory stores data transmitted through bus 318 as image data frame by frame (one image plane). From the image data, the video memory generates signals in accordance with the display device, and transmits the signals to the display device. The display device displays an image in accordance with the signals. The user can input an instruction to server 180 by operating keyboard 310 and mouse 312. Network I/F 314 is an interface connected to network 190, for enabling server 180 to communicate with external devices (such as first to fifth image forming apparatuses 100 to 108) through network 190.

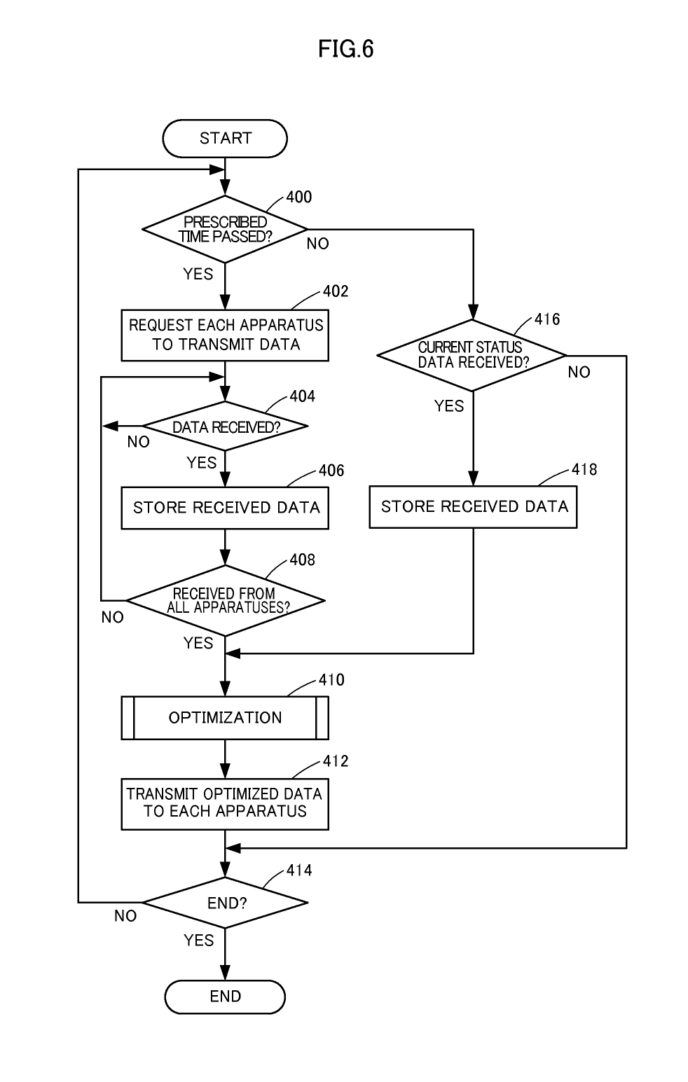

In the following, the function of server 180 of optimizing the schedule related to the energy saving mode of each of first to fifth image forming apparatuses 100 to 108 for the overall system will be specifically described. Referring to FIG. 6, the control structure of a program executed by CPU 300 of server 180 will be described. When powered ON and activated, server 180 obtains information of current time from timer 316, and stores it as transmission time information TO in a prescribed area of RAM 304. It is assumed that a time interval ΔT is stored in ROM 302.

At step 400, CPU 300 determines whether or not a prescribed time period has passed from when data transmission was last requested to first to fifth image forming apparatuses 100 to 108. Specifically, CPU 300 obtains current time T1 from timer 316, reads transmission start time T0 from RAM 304, reads the time interval ΔT from ROM 302, and determines whether or not the value obtained by subtracting transmission start time T0 from current time T1 is equal to or longer than the time interval ΔT (T1−T0≧ΔT). The transmission time information T0 of RAM 304 is updated at step 412, which will be described later. If it is determined that the prescribed time period has passed (T1−T0≧ΔT), the control proceeds to step 402. Otherwise (T1−T0<ΔT), the control proceeds to step 416. If step 400 is executed for the first time, it is determined that the prescribed time period has not yet passed and, the control proceeds to step 416.

At step 402, CPU 300 transmits data (hereinafter referred to as request data) requesting transmission of data related to current status of each image forming apparatus (hereinafter referred to as current status data) to the first to fifth image forming apparatuses 100 to 108 through network 190. As will be described later, receiving the request data from server 180, the first to fifth image forming apparatuses 100 to 108 each transmit the current status data of its own to server 180. The current status data includes at least the energy saving schedule (the schedule related to the energy saving mode) and information specifying the image forming apparatus as the source of transmission. The information specifying the source image forming apparatus may be a known MAC address, an IP address or the like.

At step 404, CPU 300 determines whether or not the current status data have been received from first to fifth image forming apparatuses 100 to 108. If it is determined that the data have been received, the control proceeds to step 406. Otherwise, step 404 is repeated.

At step 406, CPU 300 stores the received current status data in HDD 306. As will be described later, server 180 receives the current status data periodically (at every prescribed time period) or irregularly (when any of the image forming apparatuses sends the current status data without any request from server 180) and, therefore, it is possible that the current status data have already been stored in HDD 306. In that case, CPU 300 overwrites the current status data received from the same image forming apparatus in the past with the newly received current status data.

At step 408, CPU 300 determines whether or not the current status data have been received from all image forming apparatuses (first to fifth image forming apparatuses 100 to 108) as the object of management of server 180. If it is determined that the data have been received from all image forming apparatuses, the control proceeds to step 410. Otherwise, control returns to step 404, and steps 404 to 408 are repeated until the current status data from all image forming apparatuses are received.

If it is determined that the prescribed time period has not yet passed at step 400, at step 416, CPU 300 determines whether or not the current status data has been received from any of the first to fifth image forming apparatuses 100 to 108. If it is determined that the data has been received, the control proceeds to step 418. Otherwise, the control proceeds to step 414.

At step 418, as at step 406, CPU 300 stores the received current status data in HDD 306. Then, the control proceeds to step 410.

Through the above-described steps 400 to 408, 416 and 418, server 180 can receive the current status data from the first to fifth image forming apparatuses 100 to 108.

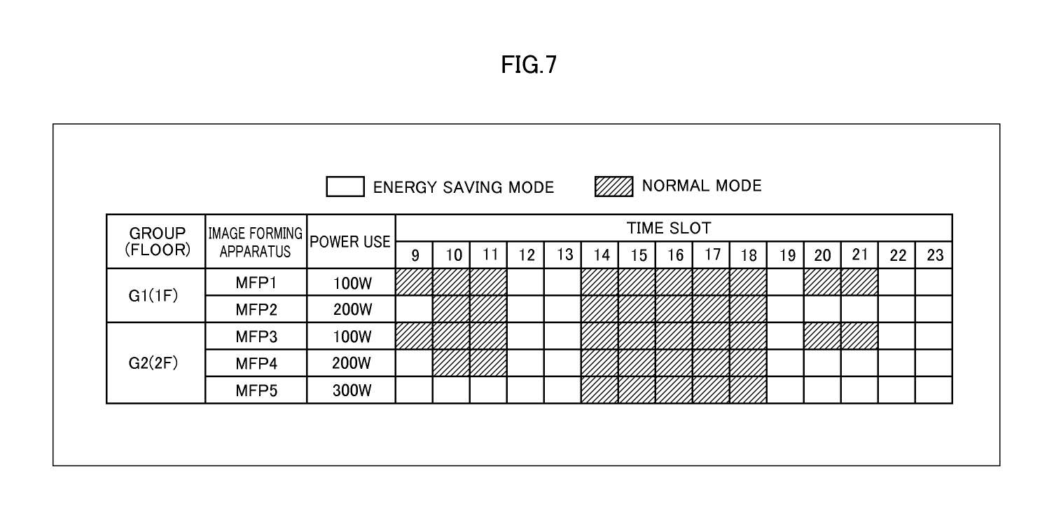

FIG. 7 shows the current status data obtained by server 180 in a form of a table. When each image forming apparatus is powered ON and activated, it operates in accordance with the energy saving schedule. The indications 1F and 2F in parenthesis of the “Group” column represent the first floor and the second floor, indicating that the image forming apparatus belonging to the group G1 is placed on the first floor and the image forming apparatus belonging to the group G2 is placed on the second floor. MFP1 to MFP5 represent information to specify the first to fifth image forming apparatuses, respectively. In the following, for simplicity of description, MFP1 to MFP5 are also used to represent the first to fifth image forming apparatuses 100 to 108. The “Power Use” represents rated electric power of each image forming apparatus. The numerals indicating time slot represents the start time of each time slot. By way of example, “9” represents the time slot from 9:00 to immediately before 10:00, and “23” represents the time slot from “23:00” to immediately before 24:00 (0:00). A hatched cell indicates that the corresponding image forming apparatus is set to the normal mode in the corresponding time slot. A white cell indicates that the corresponding image forming apparatus is set to the energy saving mode in the corresponding time slot. That the time slot from 0:00 (24:00) to 9:00 is not shown in FIG. 7 means that the power of each image forming apparatus is OFF. By way of example, MFP1 is set to the normal mode when it is turned ON at 9:00, and this state is maintained until immediately before 12:00. At 12:00, MFP1 is set to the energy saving mode, and this state is maintained until immediately before 1400. MFP1 is set to the normal mode or energy saving mode in the similar manner thereafter, and at 24:00 (0:00), the power is turned OFF. The same applies to MFP2 to MFP5.

The current status data transmitted from each image forming apparatus to server 180 may have any format. By way of example, assuming that MFPi (i=1 to 5) is a piece of information specifying each of first to fifth image forming apparatuses 100 to 108, n represents the total number of time slots, stⱼ (j=1 to n) represents the start time of a time slot, moⱼ (j=1 to n) represents a mode and PWᵢ represents power use of each image forming apparatus, the current status data may have the following format: {MFPi, (st₁, m0₁), . . . , (stⱼ, moⱼ), . . . , (stₙ, moₙ), PWᵢ}.

Further, assuming that stⱼ (j=1 to m) and etⱼ (j=1 to m) represent the start time and the end time of a time slot in which energy saving mode is set, the current status data may have the following format, with the time slot other than (stⱼ, etⱼ)(j=1 to m) being set to the normal mode: {MFPi, (st₁, et₁), . . . , (stⱼ, etⱼ), . . . , (stₘ, etₘ), PWᵢ}. If this format is used, stⱼ (j=1 to m) and etⱼ (j=1 to m) may be used to represent the start time and end time of a time slot set to the normal mode, if such relation is defined in advance between server 180 and each image forming apparatus. Then, the time slot other than (stⱼ, etⱼ) (j=1 to m) is set to the energy saving mode.

It is unnecessary to transmit the power use PWᵢ of each image forming apparatus each time. It may be transmitted only once by each image forming apparatus, and server 180 may store the received power use PWᵢ of each image forming apparatus in HDD 306 in correspondence with the information MFPi specifying each image forming apparatus. The power use PWᵢ of each image forming apparatus may be input in advance by an administrator or the like using keyboard 310 or the like and stored in HDD 306.

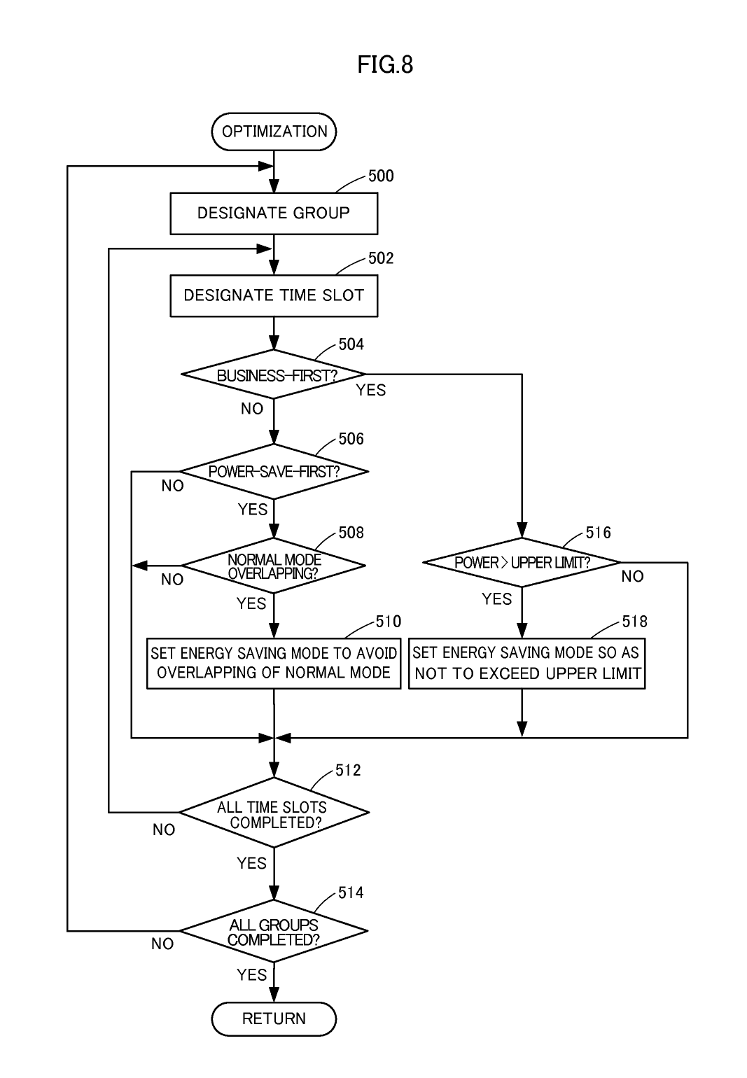

At step 410, CPU 300 executes the process of optimizing the energy saving schedule (see FIG. 7) included in the current status data received from first to fifth image forming apparatuses 100 to 108. Various methods are available for the optimization. FIG. 8 shows an example of the optimization.

At step 500 of FIG. 8, CPU 300 designates one group as an object of optimization. Here, the first group G1 or the second group G2 is designated. This is to realize optimization group by group, in consideration of the place where the image forming apparatuses are installed.

At step 502, CPU 300 designates a time slot. By way of example, in FIG. 7, one of the time slots indicated by “9” to “23” is designated.

At step 504, CPU 300 determines whether or not the time slot is a business-first time slot. The business-first time slot means that priority is given to business operation, rather than energy saving. In this time slot, setting of the energy saving mode is avoided as much as possible. The energy saving mode, however, may be set in accordance with other conditions. For example, an upper limit of total power use may be set, and the energy saving mode may be set accordingly. The business-first time slot may be set for the entire image forming system 200 or for each group, and stored in advance in HDD 306 of server 180. Here, it is assumed that as the business-first time slot, the time period from 14:00 to immediately before 17:00 is set, and that the total power used in each group should be up to 500 W even in the business-first time slot. A time slot or time slots other than the business-first time slot may be set as a time slot in which power saving is given priority, as will be described later. If it is determined to be the business-first time slot, the control proceeds to step 516. Otherwise, the control proceeds to step 506.

At step 506, CPU 300 determines whether or not is it a time slot of power-save-first. The power-save-first time slot is a time slot in which power saving is given priority rather than business operations. In this time slot, image forming apparatuses are positively set to the energy saving mode, in order to reduce power consumption as much as possible. Here, the time slot from 9:00 to immediately before 12:00 and time slot from 18:00 to immediately before 24:00 are set as the power-save-first time slot. If it is determined to be the power-save-first time slot, the control proceeds to step 508. Otherwise, the control proceeds to step 512.

At step 508, CPU 300 determines whether or not the normal modes are overlapping in the time slot designated at step 502. Specifically, CPU 300 determines whether or not the normal mode is set in two or more of the plurality of image forming apparatuses belonging to the group designated at step 500. If it is determined that two or more image forming apparatuses are in the normal mode in the designated time slot, the control proceeds to step 510. Otherwise, the control proceeds to step 512.

At step 510, for the time period designated at step 502, CPU 300 maintains the setting of normal mode in only one of the plurality of image forming apparatuses that have been set to the normal mode and changes the mode of other image forming apparatuses that have been set to the normal mode to the energy saving mode. Setting of which of the image forming apparatuses is to be kept in the normal mode may be determined arbitrarily. By way of example, of the image forming apparatuses set to the normal mode, one having the smallest power consumption is maintained in the normal mode setting, and the mode of other image forming apparatuses set to the normal mode is changed to the energy saving mode.

If it is determined at step 504 that it is in the business-first time slot, at step 516, CPU 300 determines whether or not the total power use of image forming apparatuses set to the normal mode in the time slot designated at step 502 among the plurality of image forming apparatuses belonging to the group designated at step 500 is higher than a prescribed upper limit (for example, 500W). If it is determined to be higher, the control proceeds to step 518. Otherwise, the control proceeds to step 512.

At step 518, in order to have the total power use of image forming apparatuses set to the normal mode equal to or smaller than the prescribed upper limit, CPU 300 sets the image forming apparatus or apparatuses set to the normal mode to the energy saving mode. By way of example, it determines a combination of image forming apparatuses to be kept in the normal mode, among the plurality of image forming apparatuses set to the normal mode, such that the total power use attains to the maximum value not exceeding the prescribed upper limit. Except for the thus determined image forming apparatuses, the image forming apparatuses are set to the energy saving mode.

At step 512, CPU 300 determines whether or not the process has been completed for all time slots. If it is determined to be completed, the control proceeds to step 514. Otherwise, the control returns to step 502, at which a not-yet-processed time slot is designated, and the process beginning at step 504 is repeated.

At step 514, CPU 300 determines whether or not the process has been completed for all groups. If it is determined to be completed, the program ends, and the control proceeds to step 412 of FIG. 6. Otherwise, the control returns to step 500, at which a not-yet-processed group is designated, and the process beginning at step 502 is repeated.

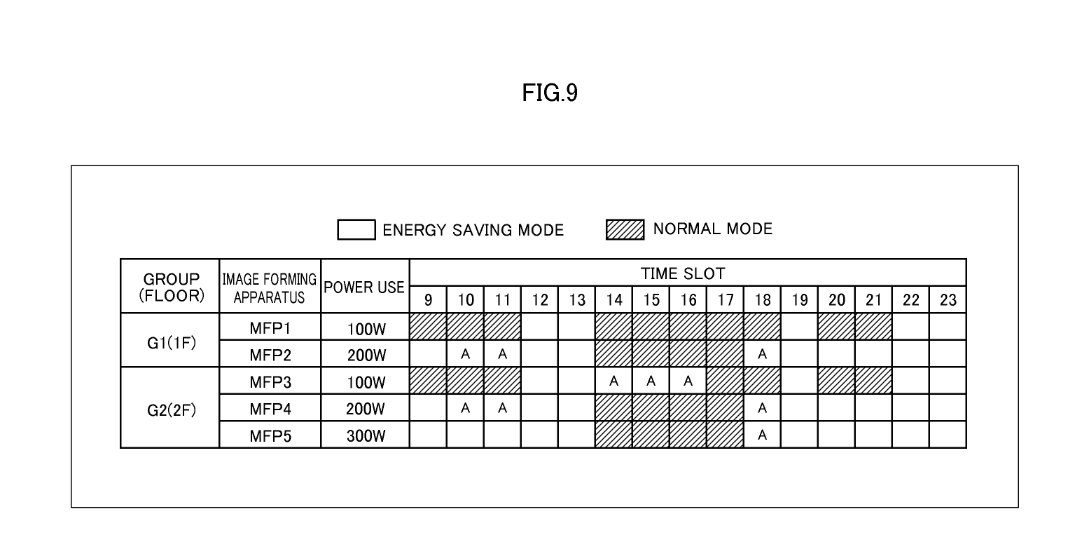

If the optimization process shown in FIG. 8 is executed on the energy saving schedule shown in FIG. 7, the optimized energy saving schedule will be as shown in FIG. 9. Cells of which mode has been changed are denoted by the character A.

By way of example, regarding two MFPs belonging to group G1, that is, MFP1 and MFP2, in time slot “10”, MFP2 is changed from the normal mode (FIG. 7) to the energy saving mode (FIG. 9). Specifically, at step 500, group G1 (the group of floor “1F” in FIG. 7) is designated, and at step 502, the time slot “10” is designated. Since the time slot “10” is not the business-first time slot (the business-first time slot is from 14:00 to immediately before 17:00), it is determined that the number of image forming apparatuses in the normal mode is excessive at step 508, and as a result, MFP2 is set to the energy saving mode. Similarly, regarding two MFPs belonging to group G1, that is, MFP1 and MFP2, in time slots “11” and “18” also, MFP2 is changed from the normal mode (FIG. 7) to the energy saving mode (FIG. 9). Namely, in the similar manner as above, at step 500, group G1 is designated, and at step 502, the time slot “11” (or “18”) is designated. Since these time slots are not the business-first time slots, it is determined that the number of image forming apparatuses in the normal mode is excessive at step 508, and as a result, MFP2 is set to the energy saving mode. In FIG. 9, of MFP1 and MFP2 that are both set to the normal mode, the mode of MFP2 of larger power use is changed to the energy saving mode. It is possible, however, to set MFP1 to the energy saving mode.

Regarding three MFPs belonging to the group G2, that is, MFP3 to MFP5, in time slots “10” and “11”, MFP4 is changed from the normal mode (FIG. 7) to the energy saving mode (FIG. 9), and in time slot “18”, MFP4 and MFP5 are changed from the normal mode (FIG. 7) to the energy saving mode (FIG. 9). Namely, in the similar manner as above, at step 500, group G2 is designated, and at step 502, the time slot “10”, “11” or “18” is designated. Since these time slots are not the business-first time slots, it is determined that the number of image forming apparatuses in the normal mode is excessive at step 508, and as a result, MFP4 (and MFP5 in time slot “18”) is set to the energy saving mode. Regarding three MFPs belonging to the group G2, in time slots “14” to “16”, MFP3 is changed from the normal mode (FIG. 7) to the energy saving mode (FIG. 9). Specifically, these time slots are business-first time slots and, therefore, steps 516 and 518 are executed, and MFP3 is changed to the energy saving mode so that the total power use of MFP3 to MFP5 does not exceed the prescribed value 500W.

The time slots other than those mentioned above are neither the business-first time slot nor the power-save-first time slot. Therefore, after the determination at step 506, the control proceeds to step 512, and the original setting is maintained. For this reason, in time slot “17”, for example, the mode is not changed in any of MFP1 to MFP5.

After the energy saving schedule is optimized in this manner at step 410, at step 412, CPU 300 transmits the optimized energy saving schedule related to each image forming apparatus to the corresponding image forming apparatus. As will be described later, each image forming apparatus receives the optimized energy saving schedule transmitted from server 180, and updates the energy saving schedule that has been stored in the apparatus with the received energy saving schedule. Thereafter, each image forming apparatus operates in accordance with the thus updated energy saving schedule. If the schedule is unchanged, transmission of the schedule to the corresponding image forming apparatus is unnecessary.

At step 414, CPU 300 determines whether or not an end instruction is received. The end instruction is, for example, power OFF of server 180. If it is determined that an end instruction is received, the program ends. Otherwise, the control returns to step 400.

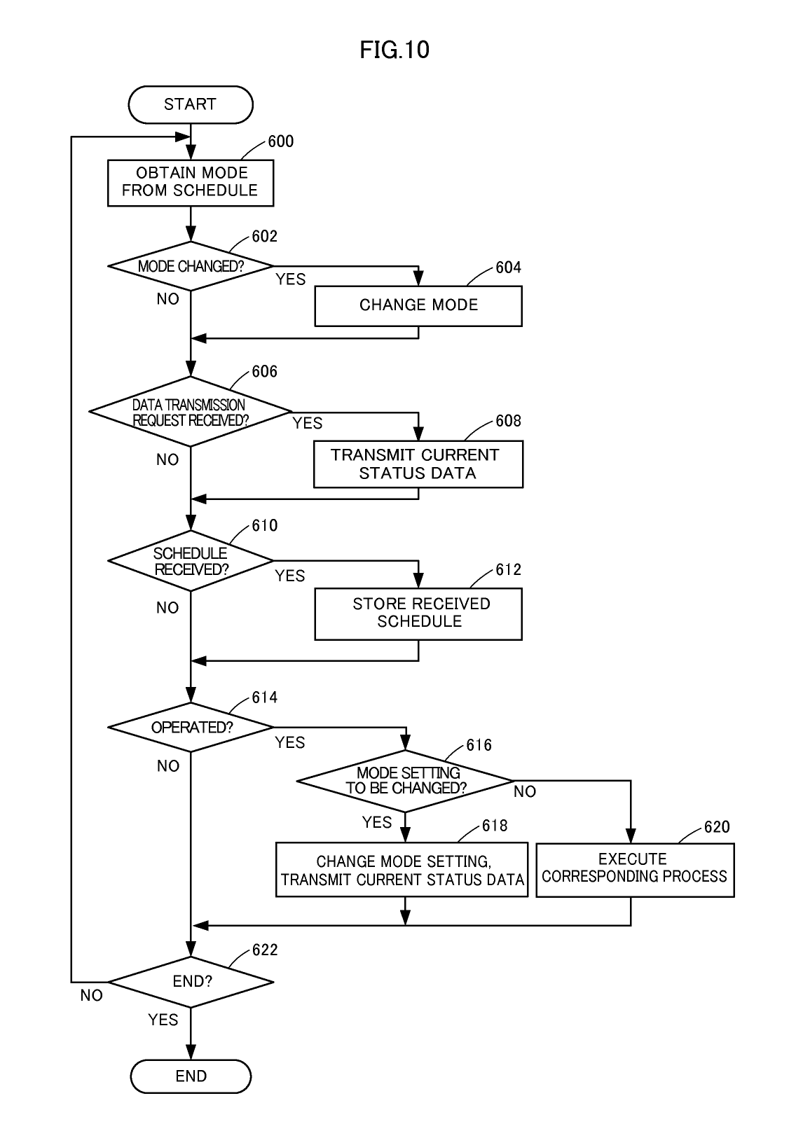

Next, referring to FIG. 10, the program executed by control unit 160 of first image forming apparatus 100 will be described. It is assumed that the energy saving schedule is set by an administrator or the like and stored in HDD 162. It is assumed that information representing current mode of first image forming apparatus 100 (current mode information) is temporarily stored in RAM or the like. The initial value of current mode information is a piece of information representing the normal mode.

After power ON of first image forming apparatus 100, at step 600, control unit 160 obtains the current time from timer 176, looks up the energy saving schedule in HDD 162, and specifies the mode that corresponds to the current time.

At step 602, control unit 160 compares the mode specified at step 600 with the mode corresponding to the current mode information temporarily stored in the RAM, and determines whether or not these modes are the same. If they are the same, it is determined that the mode has not been changed, and the control proceeds to steps 606. If they are different, it is determined that the mode has been changed, and the control proceeds to step 604. At step 604, control unit 160 changes the mode. Transition is made from the normal mode to the energy saving mode (more specifically, to the auto power shut-off mode, pre-heat mode or the like), and power supply to a prescribed internal unit or units is stopped or reduced.

At step 606, control unit 160 determines whether or not data request from server 180 (request for transmitting current status data) is received. If it is determined that the request is not received, the control proceeds to step 610. If it is determined that it has been received, the control proceeds to step 608. At step 608, control unit 160 transmits the current status data to server 180. The current status data includes the energy saving schedule and the information specifying the image forming apparatus, as described above.

At step 610, control unit 160 determines whether or not the optimized energy saving schedule (optimized at step 410 of FIG. 6 and transmitted at step 412) has been received from server 180. If it is determined that the schedule has been received, the control proceeds to step 612. At step 612, control unit 160 stores the received energy saving schedule in HDD 162 (for example, overwrites the energy saving schedule already stored in HDD 162). If it is determined that the schedule is not received, the control proceeds to step 616.

At step 614, control unit 160 determines whether or not any operation is done on first image forming apparatus 100. Since the user inputs various instructions to first image forming apparatus 100 through operation unit 130, control unit 160 determines whether or not operation unit 130 has been operated. If it is determined that an operation has been done, the control proceeds to step 616. Otherwise, the control proceeds to step 622.

At step 616, control unit 160 determines whether or not the received operation is an operation to change the mode setting. The change of mode setting is executed, for example, by control unit 160 reading the current energy saving schedule from HDD 162, displaying it on touch-panel display 132 of operation unit 130, and receiving a user operation thereto. If it is determined that an operation to change the mode setting is received, the control proceeds to step 618. Otherwise, the control proceeds to step 620.

At step 618, control unit 160 changes the energy saving schedule stored in HDD 162, and transmits the current status data including the changed energy saving schedule to server 180.

At step 620, control unit 160 executes the process corresponding to the received operation. Thereafter, the control proceeds to step 622. As described above, if an instruction to cause first image forming apparatus 100 to execute the copy function, printer function, scanner function, facsimile function or the like is received, control unit 160 executes the corresponding process.

At step 622, control unit 160 determines whether or not an end instruction is received. The end instruction is, for example, power OFF of the first image forming apparatus 100. If it is determined that an end instruction is received, the program ends. Otherwise, the control returns to step 600.

In this manner, first image forming apparatus 100 changes the mode in accordance with the energy saving schedule, and transmits the current status data of its own in response to a request from server 180. After receiving the optimized energy saving schedule, it changes the mode in accordance therewith.

As described with reference to FIGS. 6, 8 and 10 above, server 180 periodically or non-periodically receives the current status data including the energy saving schedule from the first to fifth image forming apparatuses 100 to 108, and can execute the optimization process thereon, in accordance with the conditions imposed on the overall system or on each group (for example, based on whether power saving is given priority or business is given priority). Then, server 180 can transmit the optimized energy saving schedules to, and have them executed by, the first to fifth image forming apparatuses 100 to 108. Thus, the plurality of image forming apparatus can be operated appropriately, considering both the efficiency of business operations and power saving in each group (each department).

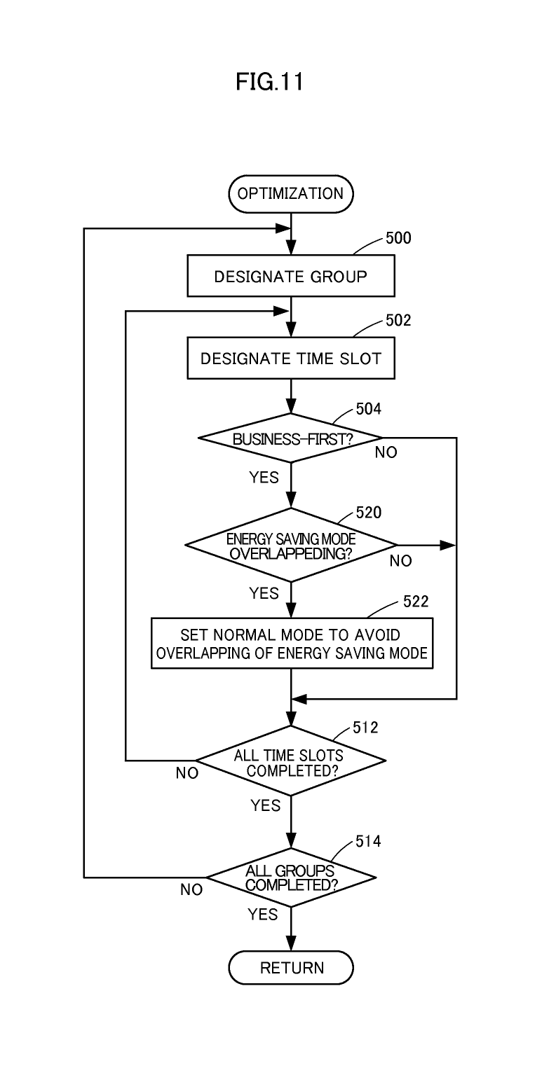

The optimization process of step 410 shown in FIG. 6 is not limited to the example shown in FIG. 8. By way of example, CPU 300 of server 180 may execute such an optimization process as shown in FIG. 11. Steps 500 to 504, 512 and 514 of FIG. 11 are the same as those of FIG. 8 and, therefore, description thereof will not be repeated here. Different from FIG. 8, in FIG. 11, the schedule in the business-first time slot is optimized. Therefore, whether or not the time is in the power-save-first time slot is not considered.

At step 520, CPU 300 determines whether or not the number of image forming apparatuses in the energy saving mode is excessive, with regard to the business-first time slot. More specifically, CPU 300 determines whether two or more of the plurality of image forming apparatuses belonging to the group designated at step 500 are set to the energy saving mode in the time slot designated at step 502. If it is determined that there are such image forming apparatuses, the control proceeds to step 522. Otherwise, the control proceeds to step 512.

At step 522, among the plurality of image forming apparatuses set to the energy saving mode in the time slot designated at step 502, CPU 300 has only one image forming apparatus kept set to the energy saving mode, and changes the mode of other image forming apparatuses that have been set to the energy saving mode to the normal mode. Which of the image forming apparatuses is to be kept in the energy saving mode may be arbitrarily determined. By way of example, of the image forming apparatuses set to the energy saving mode, one that consumes maximum power may be kept set to the energy saving mode, and other image forming apparatuses that are set to the energy saving mode may be changed to the normal mode.

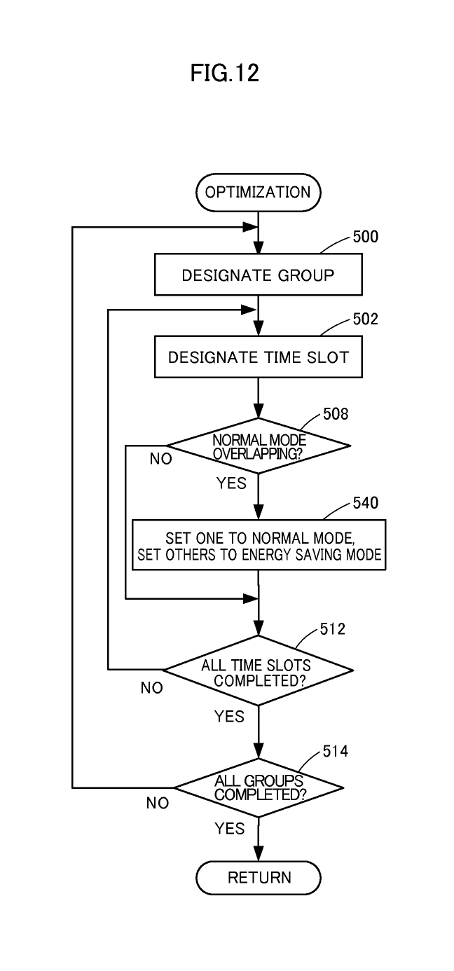

CPU 300 of server 180 may execute such an optimization process as shown in FIG. 12. Steps 500, 502, 508, 512 and 514 of FIG. 12 are the same as those of FIG. 8 and, therefore, description thereof will not be repeated here.

At step 540, among the plurality of image forming apparatuses set to the normal mode in the time slot designated at step 502, CPU 300 has only one image forming apparatus that consumes minimum power kept set to the normal mode, and changes the mode of other image forming apparatuses that have been set to the normal mode to the energy saving mode.

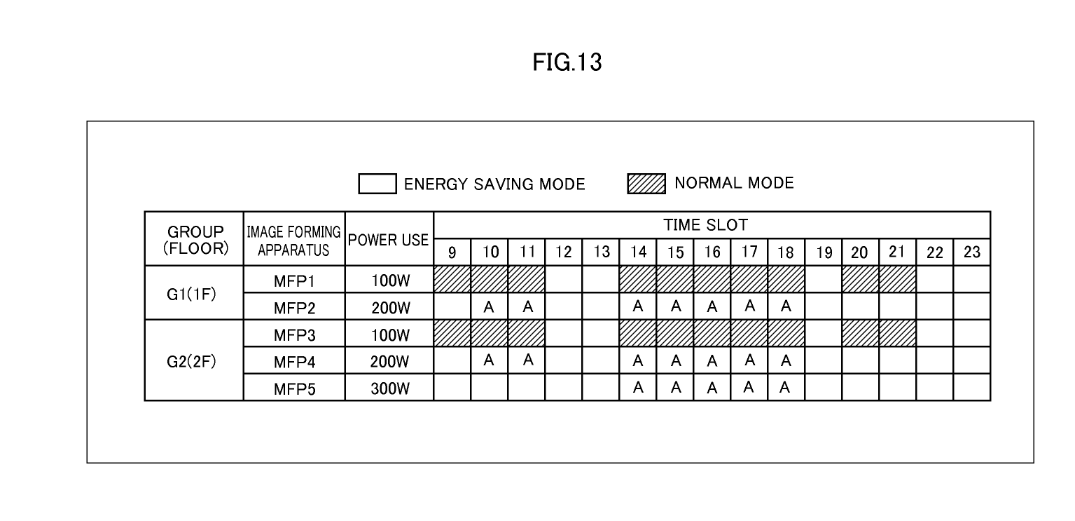

If the optimization process shown in FIG. 12 is executed on the energy saving schedule shown in FIG. 7, the optimized energy saving schedule will be as shown in FIG. 13. Cells of which mode has been changed are denoted by the character A.

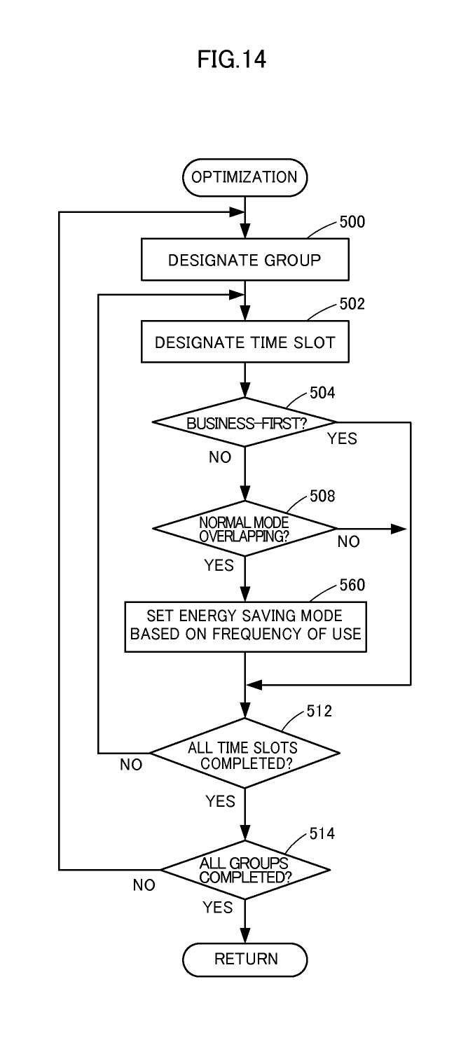

CPU 300 of server 180 may execute such an optimization process as shown in FIG. 14. Steps 500 to 504, 508, 512 and 514 of FIG. 14 are the same as those of FIG. 8 and, therefore, description thereof will not be repeated here.

At step 560, CPU 300 determines, in a time slot designated at step 502 (not the business-first time slot but a time slot in which two or more image forming apparatuses are in normal mode), the mode of each image forming apparatus in accordance with the usage rate. For example, it sets the mode of an image forming apparatus of low usage rate to the energy saving mode. Specifically, assuming that the two image forming apparatuses are set to the normal mode, one having lower usage rate is changed to the energy saving mode. If three or more image forming apparatuses are set to the normal mode, image forming apparatuses up to half the number are set to the normal mode starting from the one having highest usage rate, and the remaining image forming apparatuses are set to the energy saving mode. It is noted, however, that in all time slots in which three or more image forming apparatuses are set to the normal mode, each image forming apparatus should be set to the normal mode in at least one time slot.

Here, the usage rate is determined, for example, in the following manner. When server 180 requests each image forming apparatus to transmit the current status data, each image forming apparatus transmits information related to how long the image forming apparatus was used in the previous day (hereinafter also referred to as operation time) and information related to the remaining amount of consumables (such as toner and recording paper) as well as the energy saving schedule, as the current status data. Server 180 stores the received current status data in association with information of time of reception (including information of date, month and year), as history data of each image forming apparatus, in HDD 306. Thereafter, server 180 collects history data for a prescribed time period for each image forming apparatus, and calculates the usage rate.

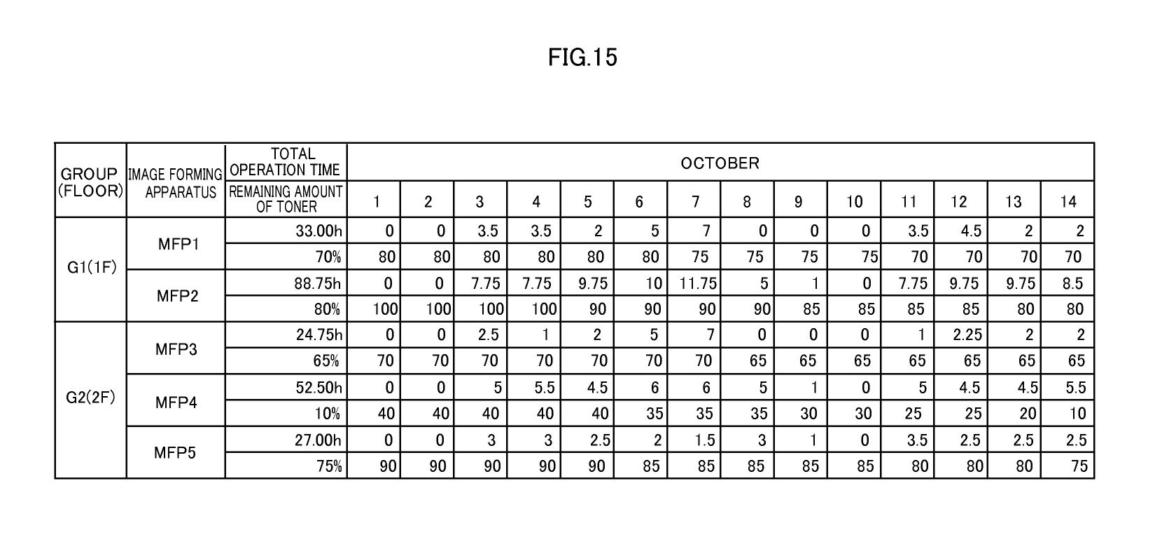

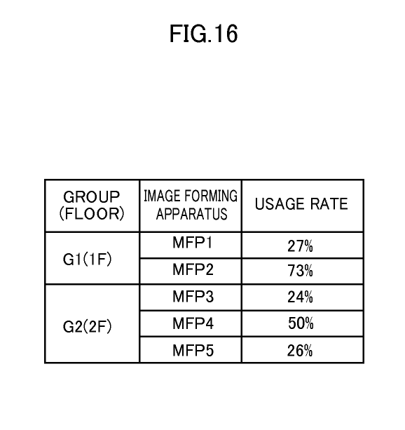

Assuming that server 180 stores the history data of MFP1 to MFP5 such as shown in FIG. 15, the usage rate of respective image forming apparatuses are as shown in FIG. 16. FIG. 15 shows history data from October 1 to October 14, including the operation time per day (h) and remaining amount of toner (%). The total operation time is the sum of operation time from October 1 to October 14. The remaining amount of toner is the amount on the last day (October 14). The usage rate is the value (%) obtained by dividing the total operation time of each image forming apparatus by the sum of total operation time of image forming apparatuses belonging to the same group. By way of example, the usage rate of MFP1 is calculated as total operation time of MFP1/(total operation time of MFP1+total operation time of MFP2).

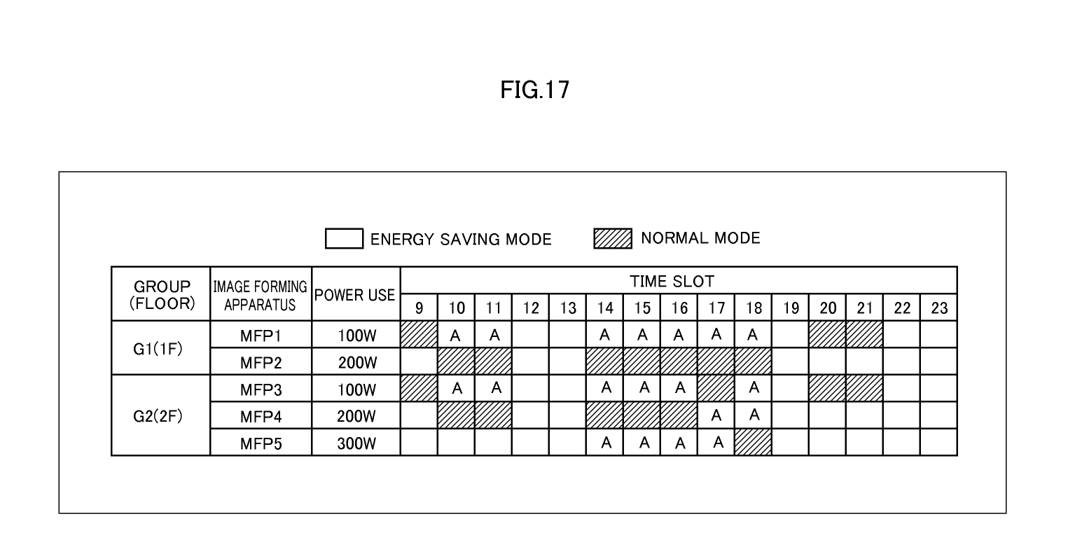

If the optimization process shown in FIG. 14 is executed on the energy saving schedule shown in FIG. 7, using the usage rate of FIG. 16, the optimized energy saving schedule will be as shown in FIG. 17. Cells of which mode has been changed are denoted by the character A. Two image forming apparatuses belong to group G1. In time slots “10”, “11” and “14” to “18” in which the two apparatuses are both set to the normal mode in FIG. 7, MFP2 of higher usage rate (73%) is kept in the normal mode while MFP1 of lower usage rate (27%) is changed to the energy saving mode, in FIG. 17.

On the other hand, three image forming apparatuses belong to group G2. In time slots “10” and “11” in which two image forming apparatuses are set to the normal mode in FIG. 7, MFP4 of higher usage rate (50%) is kept in the normal mode and MFP3 of lower usage rate (24%) is changed to the energy saving mode, similar to the above. In time slots “14” to “18” of FIG. 7, three image forming apparatuses are set to the normal mode. In time slots “14” to “18”, on condition that each image forming apparatus is set to the normal mode in at least one of the time slots “14” to “18”, apparatuses up to half of the number (in this example, one) are set to the normal mode, and the remaining apparatuses are set to the energy saving mode. In FIG. 17, in time slots “14” to “18”, priority is given to MFP4 of high usage rate, and this apparatus is set to the normal mode in continuous time slots “14” to “16”. In remaining time slots “17” and “18”, MFP3 or MFP5 of lower usage rate is set to the normal mode.

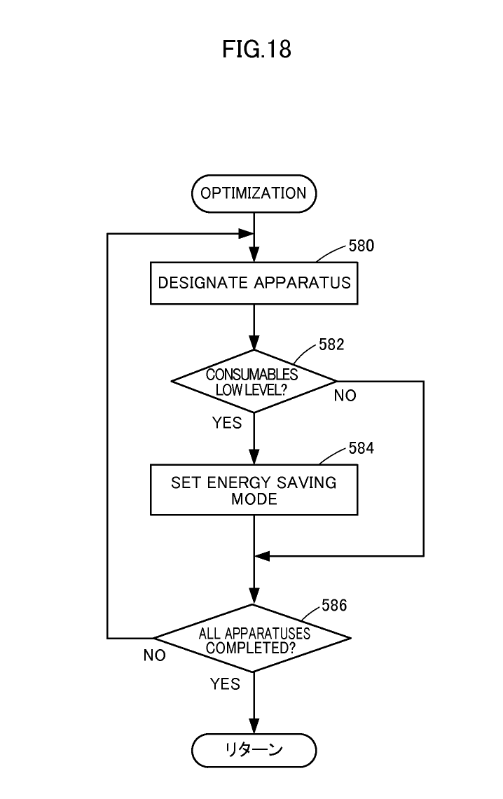

CPU 300 of server 180 may execute such an optimization process as shown in FIG. 18. In the process shown in FIG. 18, an image forming apparatus of which remaining amount of toner is small is set to the energy saving mode, to limit its use. This approach is on condition that the current status data which the server 180 receives from each image forming apparatus in the flowchart of FIG. 6 contains the information related to the remaining amount of consumables (toner, recording paper and the like).

At step 580, CPU 300 designates one piece of information specifying an image forming apparatus. For example, one of MFP1 to MFP5 is designated.

At step 582, CPU 300 determines whether or not the remaining amount of consumables is small in the image forming apparatus corresponding to the information designated at step 580. Specifically, CPU 300 reads the remaining amount of consumables of the image forming apparatus from HDD 306, and determines whether it is equal to or lower than a prescribed value. If it is determined that the remaining amount of consumables is low (remaining amount of consumables≦prescribed value), the control proceeds to step 584. Otherwise (remaining amount of consumables>prescribed value), the control proceeds to step 586. The prescribed value is, for example, 10%.

At step 584, CPU 300 reduces the time slots in which the image forming apparatus corresponding to the information designated at step 580 is set to the normal mode. Specifically, CPU 300 changes part of or all of the time slots set to the normal mode to the energy saving mode.

At step 586, CPU 300 determines whether or not the process has been completed for all image forming apparatuses. If it is determined to be completed, the program ends, and the control proceeds to step 412 of FIG. 6. Otherwise, the control returns to step 580, at which information specifying a not-yet-processed image forming apparatus is designated, and the process beginning at step 582 is repeated.

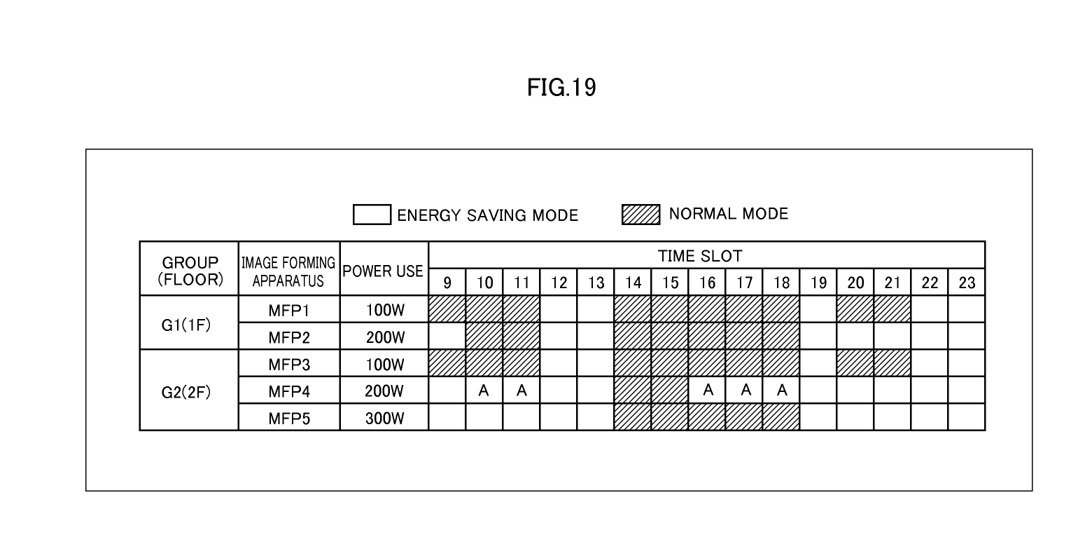

By way of example, if the optimization process shown in FIG. 18 is executed on the energy saving schedule shown in FIG. 7, using the remaining amount of toner of FIG. 15, the optimized energy saving schedule will be as shown in FIG. 19. Since the remaining amount of toner of MFP4 is 10%, its operational mode is changed to the energy saving mode in time slots “10”, “11” and “16” to “18”. Since the remaining amount of toner is larger than 10% in other image forming apparatuses, their modes are not changed. How many time slots are to be set to the energy saving mode if the remaining amount of toner is smaller than the prescribed value may be determined arbitrarily. It is noted, however, that the time period set to the energy saving mode is made longer as the remaining amount of toner becomes smaller.

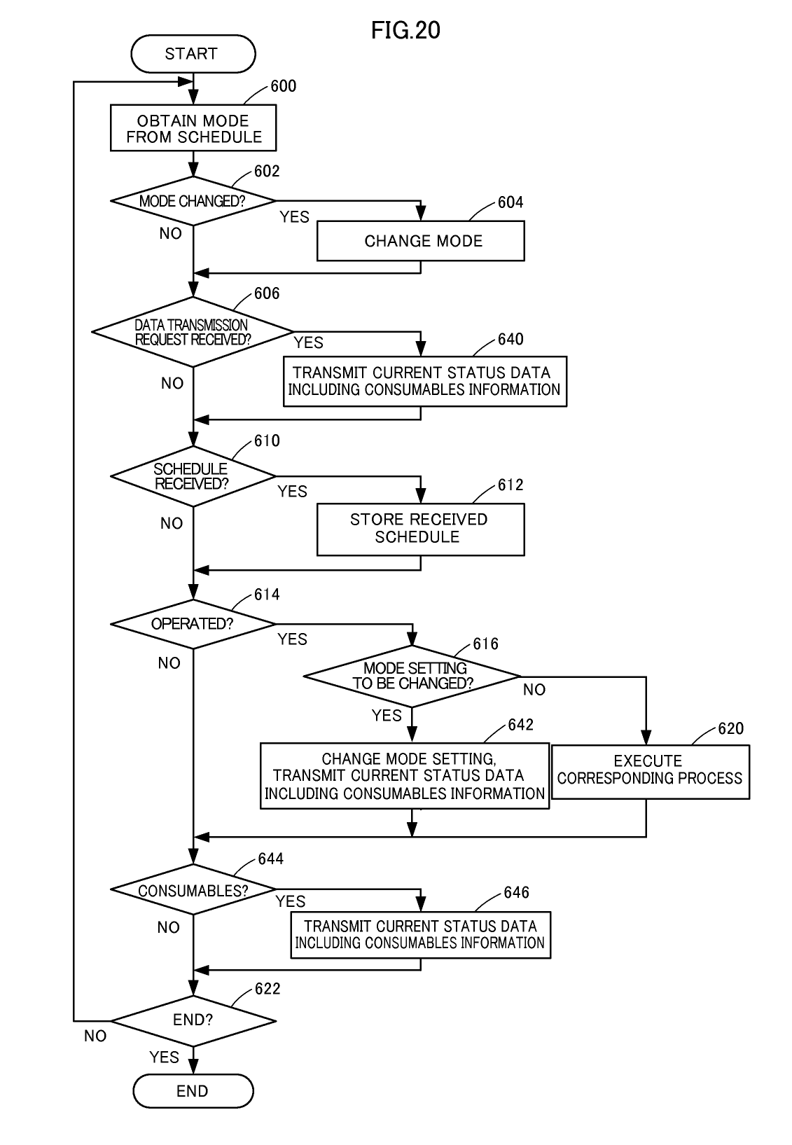

The program executed by control unit 160 of first image forming apparatus 100 is not limited to that shown in FIG. 10. By way of example, the program shown in FIG. 20 may be used. Steps 600 to 606, 610 to 616, 620 and 622 are the same as those of FIG. 10 and, therefore, description thereof will not be repeated here.

At step 640, control unit 160 transmits the current status data including the energy saving schedule and the information related to the remaining amount of consumables to server 180.

At step 642, control unit 160 changes the energy saving schedule stored in HDD 162 in accordance with a user operation to change the mode setting, and transmits the current status data including the changed energy saving schedule and the information related to the remaining amount of consumables to server 180.

At step 644, control unit 160 determines whether or not the consumables are exchanged or replenished. Exchange or replenishment of consumables may be detected, for example, by using a known sensor. Alternatively, exchange of consumables may be input to the image forming apparatus by the user, through operation unit 130. If it is determined that the consumables has been exchanged or replenished, the control proceeds to step 646. Otherwise, the control proceeds to step 622.

At step 646, control unit 160 measures the remaining amount of consumables, and transmits it, together with the energy saving schedule, as the current status data to server 180. The remaining amount of consumables (toner, recording paper and the like) can be obtained by a known method. By way of example, the method of measuring remaining amount of toner in a toner cartridge may include an optical method, sound and vibration method, capacitance type method, float method, driving load detecting type method and rotation number counting method. The method of measuring remaining amount of recording paper may include a method of measuring height of recording paper in a tray using a sensor.

The reason why the image forming apparatus is set to the energy saving mode to prevent usage when the remaining amount of consumables is low is as follows. Assume that consumable store is used up during copying of a large number of copies, and the image forming apparatus is stopped. If the user does not notice the stop of operation immediately, the temperature at the fixing unit decreases. Then, it takes extra power and time to re-heat the fixing unit to a high temperature.

In the optimization process of FIG. 8, step 516 is executed if business is given priority. Depending on the conditions imposed on the system, however, the process of steps 516 and 518 may not be executed. Depending on situation, the process of steps 506 to 510 may not be executed.

The optimization processes shown in FIGS. 8, 11, 12, 14 and 18 are not incompatible with each other, and may not necessarily be executed exclusively. Part of the optimization process may appropriately be interchanged. For instance, in place of steps 516 and 518 of FIG. 8, steps 520 and 522 of FIG. 11 may be used. In place of step 510 of FIG. 8, step 540 of FIG. 12 or step 560 of FIG. 14 may be used.

At step 510 and/or step 518 of FIG. 8, the image forming apparatus to be set to the energy saving mode may be determined considering the remaining amount of consumables as in FIG. 18. Similarly, at step 522 of FIG. 11, step 540 of FIG. 12 and at step 560 of FIG. 14, the remaining amount of consumables may be taken into consideration.

The optimization processes shown in FIGS. 8, 11, 12, 14 and 18 may be executed in a serial manner. By way of example, after changing the schedule in consideration of remaining amount of consumables in accordance with FIG. 18, the optimization process of FIG. 8, 11, 12 or 14 may be executed.

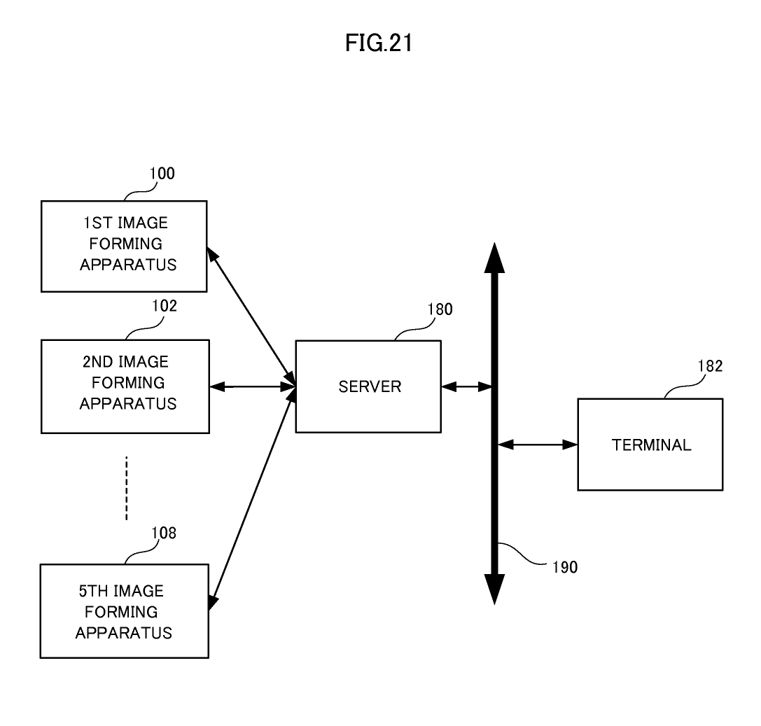

The configuration of image forming system 200 is not limited to that shown in FIG. 1. For instance, a configuration shown in FIG. 21 in which a plurality of image forming apparatuses 100 to 108 are connected to sever 180 may also be used.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. A server computer, comprising:
a receiving unit receiving, through a network, from each of a plurality of image forming apparatuses, a schedule including information related to a period in which each image forming apparatus enters an energy saving mode;
an analyzing unit analyzing said received schedule;
a changing unit changing said schedule in accordance with the result of analysis by said analyzing unit; and
a transmitting unit transmitting the changed schedule to the corresponding image forming apparatus.

2. The server computer according to claim 1, wherein
said analyzing unit calculates total sum of power use of prescribed image forming apparatuses not set to the energy saving mode among said plurality of image forming apparatuses and specifies an excess period in which the total sum exceeds a prescribed value in said schedule; and
said changing unit sets at least one of said prescribed image forming apparatuses to the energy saving mode so as to have said total sum equal to or lower than said prescribed value in said excess period, and thereby changes the schedule of said image forming apparatus.

3. The server computer according to claim 1, wherein
said analyzing unit specifies, in the schedules of at least two of image forming apparatuses among said plurality of image forming apparatuses, an energy saving mode overlapping period in which periods set to the energy saving mode overlap; and
said changing unit changes the schedules of said at least two image forming apparatuses such that of said at least two image forming apparatus, except for one of the image forming apparatuses, the remaining image forming apparatuses are not set to the energy saving mode in said energy saving mode overlapping period.

4. The server computer according to claim 1, wherein
said receiving unit receives information related to operating time of each image forming apparatus, from each of said plurality of image forming apparatuses;
said analyzing unit includes a calculating unit calculating relative usage rate from said information related to the operating time, for said plurality of image forming apparatuses; and
said changing unit changes the schedules of said plurality of image forming apparatuses such that the time period in which an image forming apparatus having smaller usage rate is set to the energy saving mode becomes longer.

5. An image forming system, comprising:
the server computer according to claim 1; and
a plurality of image forming apparatuses; wherein
each of said image forming apparatuses transmits a schedule including information related to a period in which each image forming apparatus enters an energy saving mode to said server computer, receives the schedule changed by said server computer, and operates in accordance with said received schedule.
